(19) United States
(12) Patent Application Publication
(10) Pub. No.: US 2026/0094901 A1
(43) Pub. Date: Apr. 2, 2026

(54) FREEFORM BATTERIES

(71) Applicant: Apple Inc., Cupertino, CA (US)

(72) Inventors: Karl A. Gazdowski, Los Gatos, CA (US); Premanand Ramadass, San Mateo, CA (US); Stephen J. Wisler, San Francisco, CA (US); Ibuki Kamei, Santa Clara, CA (US); Nathan L. Creado, San Jose, CA (US); Thomas A. Boehler, San Jose, CA (US); Yao Lu, San Jose, CA (US); Brian J. Haskins, Redwood City, CA (US)

(73) Assignee: Apple Inc., Cupertino, CA (US)

(21) Appl. No.: 19/340,691

(22) Filed: Sep. 25, 2025

Related U.S. Application Data
(60) Provisional application No. 63/700,392, filed on Sep. 27, 2024.

(51) Int. Cl. H01M 50/102; H01M 10/04; H01M 10/42; H01M 50/119; H01M 50/169; H01M 50/284; H01M 50/296

(52) U.S. Cl. CPC H01M 50/102; H01M 10/0468; H01M 10/049; H01M 10/425; H01M 50/119; H01M 50/169; H01M 50/284; H01M 50/296; H01M 2010/4271

(57) ABSTRACT

Batteries having convoluted, freeform shapes. These batteries can have curved and twisted surfaces that are freeform and do not have a constant radius or degree of rotation. A stack of battery layers can undergo a two-step heat press. The first heat press can be applied to the battery layers in a limited, low-stress region. This heat-press step can help to reduce delamination during a second heat-press step. In this second heat-press step, some or all of the battery layers can be pressed into a freeform shape and heat can be applied. The battery layers can then be placed in an enclosure.

### CROSS-REFERENCES TO RELATED APPLICATIONS

This application claims the benefit of U.S. Provisional Application No. 63/700,392, filed on Sep. 27, 2024, which is incorporated by reference.

### BACKGROUND

The number of types of electronic devices that are commercially available has increased tremendously the past few years and the rate of introduction of new electronic devices shows no signs of abating. Electronic devices such as tablet computers, laptop computers, all-in-one computers, desktop computers, smart phones, storage devices, wearable-computing devices, portable media players, portable computing devices, navigation systems, monitors, audio devices, remotes, adapters, and others have become ubiquitous.

Many of these devices can have convoluted shapes that do not include many, if any, planar surfaces and orthogonal intersections. In particular, wearable computing devices can have complex shapes arranged for an anatomical interface. Many of these devices can be battery powered so that users can move while wearing them without being tethered to an external power supply. But these batteries typically have enclosures that have planar surfaces and orthogonal intersections. Thus, what is needed are batteries having convoluted, freeform shapes.

### SUMMARY

Accordingly, embodiments of the present invention can provide batteries having convoluted, freeform shapes. These batteries can have curved and twisted surfaces that are freeform and do not have a constant radius or degree of rotation. A battery core undergo a two-step heat press. The first heat press can be applied to the battery core layers in a limited, low-stress region, or the first heat press can be applied across the battery core layers. This heat-press step can help to reduce delamination during a second heat-press step. In this second heat-press step, some or all of the battery core layers can be pressed into a freeform shape while heat is applied. The battery core can then be placed in an enclosure.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1A and FIG. 1B illustrate a battery having a freeform shape according to an embodiment of the present invention;

FIG. 1C and FIG. 1D illustrate another battery having a freeform shape according to an embodiment of the present invention;

FIG. 1E and FIG. 1F illustrate another battery having a freeform shape according to an embodiment of the present invention;

FIG. 2 illustrates a cross-section of the battery of FIG. 1A and FIG. 1B;

FIG. 3 is an exploded view of the battery of FIG. 1A and FIG. 1B;

FIG. 4 illustrates a cross-section of the battery core of FIG. 1A and FIG. 1B;

FIG. 5 illustrates an optional first heat-press step used in the formation of a battery core having a freeform shape according to an embodiment of the present invention;

FIG. 6 illustrates a second heat-press step used in the formation of a battery core having a freeform shape according to an embodiment of the present invention;

FIG. 7 is a flowchart of a method of manufacturing a battery core having a freeform shape according to an embodiment of the present invention;

FIG. 8 illustrates a system for sealing an enclosure for the battery of FIG. 1A and FIG. 1B;

FIG. 9 illustrates a method of sealing an enclosure for a battery having a freeform shape according to an embodiment of the present invention;

FIG. 10A and FIG. 10B illustrate another battery having a freeform shape according to an embodiment of the present invention;

FIG. 11 is an exploded view of the battery of FIG. 10A and FIG. 10B;

FIG. 12 is an exploded view of another battery according to an embodiment of the present invention;

FIG. 13 is another exploded view the battery of FIG. 12;

FIG. 14 illustrates the battery of FIG. 12 with battery pack components according to an embodiment of the present invention; and

FIG. 15 illustrates cross-section views of the battery of FIG. 1A and FIG. 1B and the battery of FIG. 10A and FIG. 10B positioned in corresponding electronic devices according to an embodiment of the present invention.

### DESCRIPTION OF ILLUSTRATIVE EMBODIMENTS

Embodiments of the present invention can provide batteries having freeform shapes and formfactors. These batteries can be curved or twisted, or both, along a first axis, such as a major axis. A curve along the major axis might not have a consistent radius of curvature along its length, though in these and other embodiments of the present invention the radius of curvature could be constant. The twist along the first or major axis can also be freeform, that is, the twist might not have the same degree of rotation along the first or major axis, though in these and other embodiments of the present invention the degree of rotation of the twist could be constant. These batteries can be curved or twisted, or both, along a second axis, such as a minor axis. A curve along the minor axis might not have a consistent radius of curvature along its length, though in these and other embodiments of the present invention the radius of curvature could be constant. The twist along the second or minor axis can also be freeform, that is, the twist might not have the same degree of rotation along the second or minor axis, though in these and other embodiments of the present invention the degree of rotation of the twist could be constant. In these and other embodiments of the present invention, the battery might have a different shape or form factor and there might not be a major and a minor axis. These batteries can also be curved and twisted according to embodiments of the present invention.

In these and other embodiments of the present invention, the battery can be housed in a metal enclosure. The metal enclosure can be deep drawn, stamped, or otherwise formed to have these curves and twists.

In these and other embodiments of the present invention, a battery core can be curved and twisted to be efficiently positioned in the enclosure. These curves and twists can be imparted to the battery core using either a one or two-step heat-press process. In a first optional step, a battery core can be placed on a first surface. The first surface can be planar or nonplanar. A second surface can contact a portion of a top of the battery core. The second surface can be planar or nonplanar. Heat and pressure can be applied by either or both the first surface and the second surface to improve a lamination in the portion of the battery core. The portion of the battery core can be selected as having a low curvature and low stress. This can help to prevent delamination of the portion of the battery core.

In a second heat-press step, the battery core can be placed on a first nonplanar surface. A second nonplanar surface can be applied to a second nonplanar surface. The first nonplanar surface and second nonplanar surface can be parallel. Heat and pressure can be applied by the first nonplanar surface and the second nonplanar surface to the battery core. This heat and pressure can impart some of the necessary curvature and twists to battery core.

In these and other embodiments of the present invention, it might be desirable that a battery core have one or more curves that are not able to be achieved with a heat-press step. Accordingly, in these and other embodiment of the present invention, sides or ends of a battery core can be cut or trimmed to achieve the desired form factor. This trimming can be done either before or after either the optional first or second heat-press steps or at other times during manufacturing. This cutting or trimming can be performed individually on layers of the batteries or it can be performed on groups of layers or an entire stack of layers. Some or all of the layers can be trimmed at different times during manufacturing.

The enclosures for these batteries can include two or more sections. These sections can be laser welded together. But since the enclosure can include curves and twists, the laser might need to change its focal length as the sections are welded together. Accordingly, embodiments of the present invention can utilize a laser that can change its focal length as the laser changes position during the welding of the two sections. An example of one such battery is shown in the following figures.

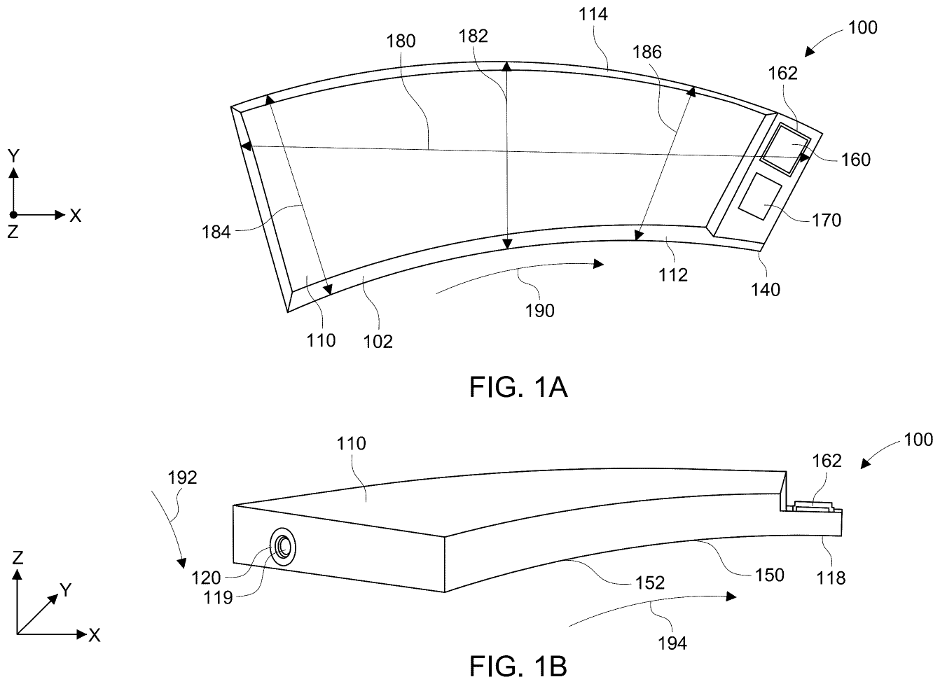

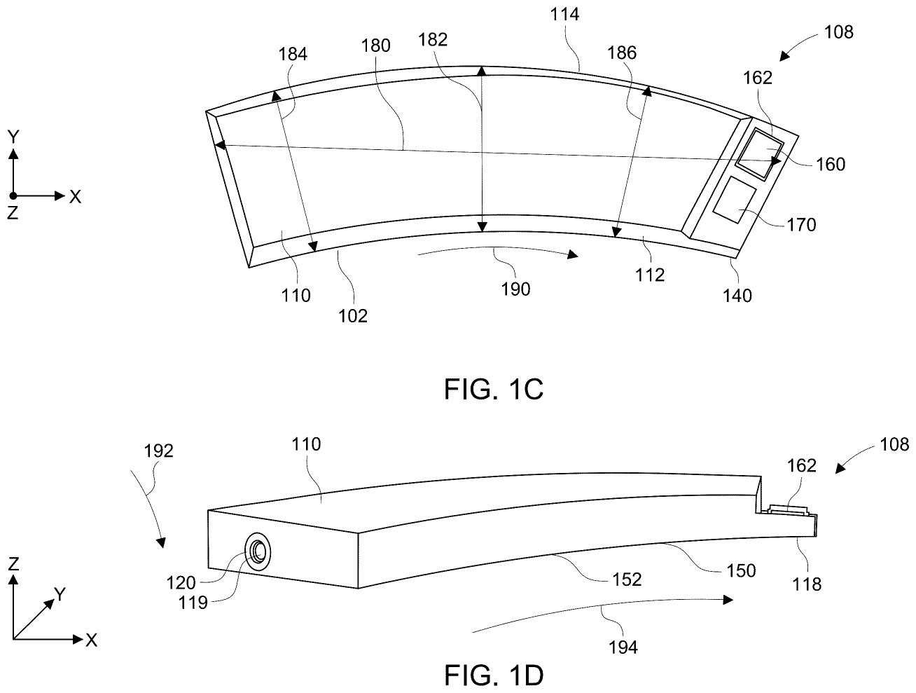

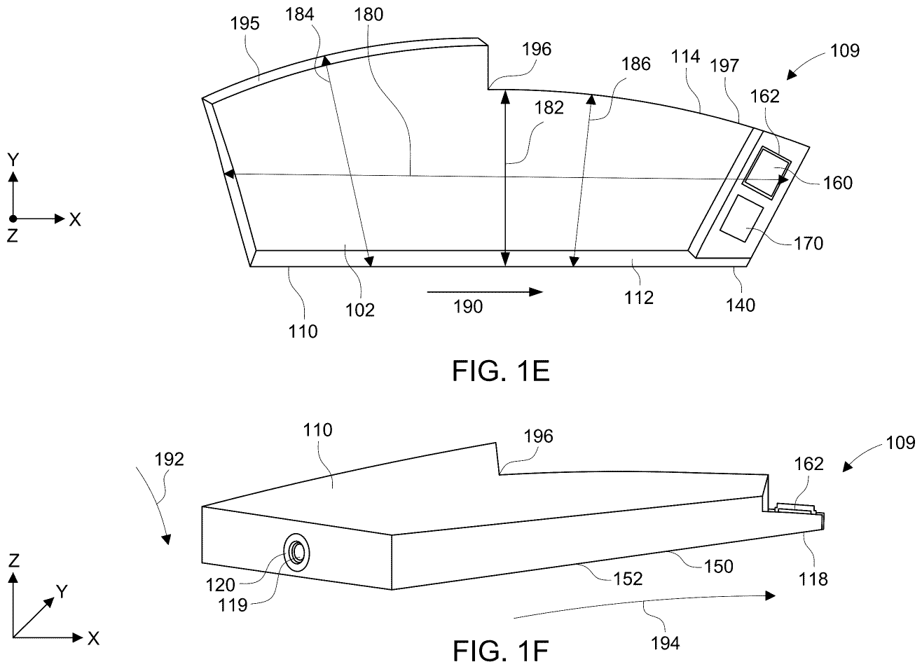

FIG. 1A and FIG. 1B illustrate a battery having a freeform shape according to an embodiment of the present invention. Battery 100 can be curved or twisted along major axis 180 and can be curved or twisted along minor axis 182. Battery 100 can be flat or substantially flat along major axis 180 and can be flat or substantially flat along minor axis 182. In this example, battery 100 can include curve 190 in the X direction along major axis 180. Curve 190 can be freeform, that is, curve 190 might not have a consistent radius of curvature along its length, though in these and other embodiments of the present invention the radius of curvature can be constant. Battery 100 can further include curve 194 in the Z direction along major axis 180. Curve 194 can also be freeform, that is, curve 194 might not have a consistent radius of curvature along its length, though in these and other embodiments of the present invention the radius of curvature could be constant. Battery 100 can further include twist 192 in the minor axis 182 around major axis 180. Twist 192 can also be freeform, that is, twist 192 might not have the same degree of rotation along major axis 180, though in these and other embodiments of the present invention the degree of rotation of twist 192 could be constant.

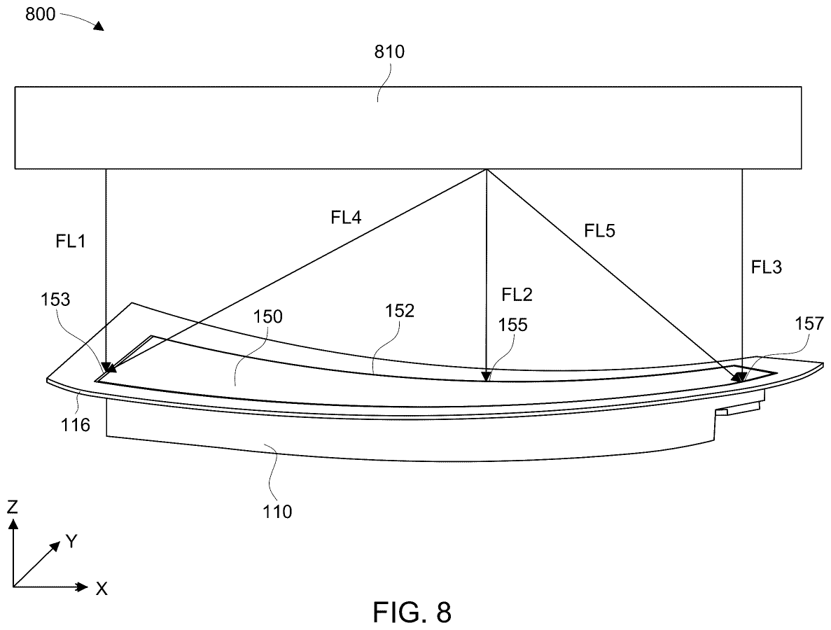

Battery 100 can be enclosed in a metal can or enclosure 102 that includes top can 110 and cover 150. Top can 110 and cover 150 can be sealed together along or near edge 152 (shown further in FIG. 8) to form enclosure 102. Top can 110 can include flange portion 118. Top can 110 and cover 150 can be formed of metal, they can be metallic, or they can be formed of other materials. Top can 110 and cover 150 can be formed of aluminum, stainless steel, recycled stainless steel or other materials. Top can 110 and cover 150 can be formed by deep drawing, metal injection molding, 3D printing, stamping, extrusion, or other process.

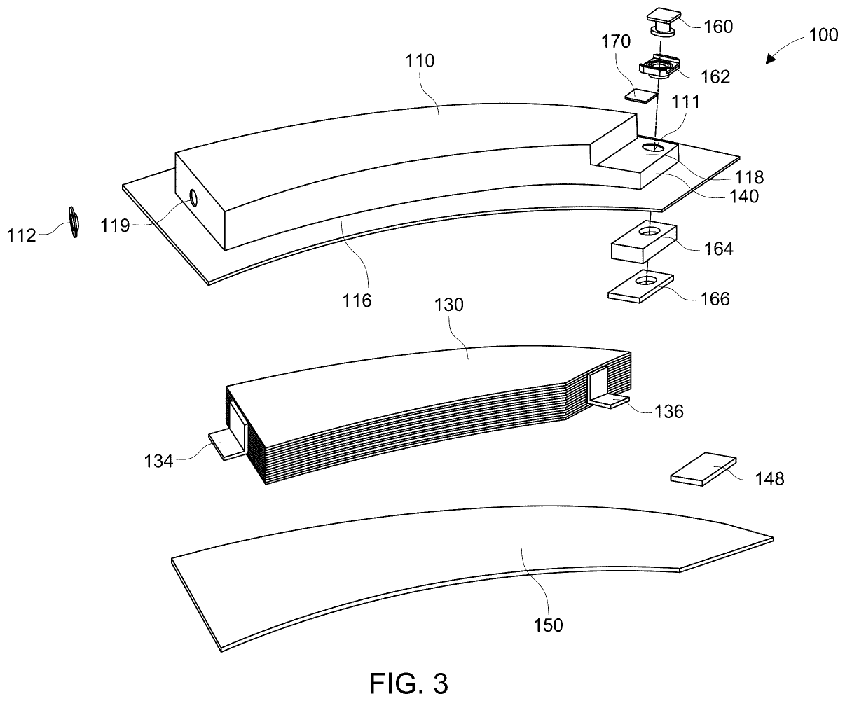

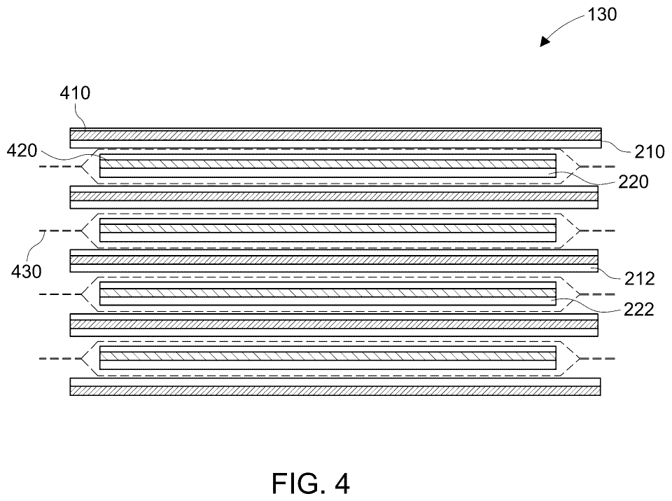

Battery core 130 (shown in FIG. 3) can be located in enclosure 102. Battery core 130 can employ various chemistries. Battery core 130 can include electrolytes (not shown) that are placed in enclosure 102 through fill hole 119. Fill hole 119 can be capped or sealed by seal 120. Details of battery core 130 are shown below in FIG. 4.

Tab 134 (shown in FIG. 3) can connect anode current collectors 410 (shown in FIG. 4) of battery core 130 to enclosure 102. Tab 136 (shown in FIG. 3) can connect cathode current collectors 420 to internal tab 166 (shown in FIG. 3.) Rivet 160 can be riveted to internal tab 166 (shown in FIG. 3) to form a positive terminal for battery 100. Rivet 160 can be insulated by external gasket 162 and internal gasket 164 (shown in FIG. 3). Internal gasket 164 can further insulate internal tab 166. Insulator 148 (shown in FIG. 3) can insulate internal tab 166 from cover 150. Negative weld-pad 170 can be soldered, laser welded, or otherwise fixed to a top surface of flange 140 to provide a negative terminal for battery 100.

This arrangement can provide a battery 100 having flange 140 at a first end and fill hole 119 and its seal 120 at a second end. Flange 140 can be formed by flange portion 118 of top can 110 and an adjacent portion of cover 150. Flange 140 can support rivet 160 and negative weld-pad 170 at a first end of the battery. Fill hole 119 can be in a side of top can 110 at the second end of the battery. By putting fill hole 119 and its seal 120 at a second end, more room is available for rivet 160, the positive terminal, and negative weld-pad 170, the negative terminal on flange 140. This can allow reductions in the width in the direction of the minor axis 182.

These battery cases can have different sizes. For example, battery 100 can have a length along major axis 180 of or approximately 10 mm, 20 mm, 30 mm, 40 mm, 50 mm, or more than 50 mm. Battery 100 can have a length along minor axis 182 of or approximately 4 mm, 5 mm, 7 mm, 9 mm, 11 mm, or more than 11 mm. Battery 100 can have a height of 0.5 mm, 1.0 mm, 1.5 mm, 2.5 mm, 3.0 mm, 4.0 mm, 5.0 mm, or more than 5.0 mm. Enclosure 102 can have a thickness of 50 microns, 75 microns, 100 microns, 150 microns, or more than 150 microns.

In this example, battery 100 can taper towards flange 140. For example, width 184 can be greater than width 186. That is, side 112 can be nonparallel or oblique to side 114. In these and other embodiments of the present invention, side 112 can be parallel to side 114. An example is shown in the following figure.

FIG. 1C and FIG. 1D illustrate a battery having a freeform shape according to an embodiment of the present invention. Battery 108 can be curved or twisted along major axis 180 and can be curved or twisted along minor axis 182. Battery 100 can be flat or substantially flat along major axis 180 and can be flat or substantially flat along minor axis 182. In this example, battery 108 can include curve 190 in the X direction along major axis 180. Curve 190 can be freeform, that is, curve 190 might not have a consistent radius of curvature along its length, though in these and other embodiments of the present invention the radius of curvature can be constant. Battery 108 can further include curve 194 in the Z direction along major axis 180. Curve 194 can also be freeform, that is, curve 194 might not have a consistent radius of curvature along its length, though in these and other embodiments of the present invention the radius of curvature could be constant. Battery 108 can further include twist 192 in the minor axis 182 around major axis 180. Twist 192 can also be freeform, that is, twist 192 might not have the same degree of rotation along major axis 180, though in these and other embodiments of the present invention the degree of rotation of twist 192 could be constant.

Battery 108 can be enclosed in a metal can or enclosure 102 that includes top can 110 and cover 150. Top can 110 and cover 150 can be sealed together along or near edge 152 (shown further in FIG. 8) to form enclosure 102. Top can 110 can include flange portion 118. Top can 110 and cover 150 can be formed of metal, they can be metallic, or they can be formed of other materials. Top can 110 and cover 150 can be formed of aluminum, stainless steel, recycled stainless steel or other materials. Top can 110 and cover 150 can be formed by deep drawing, metal injection molding, 3D printing, stamping, extrusion, or other process.

Battery core 130 (shown in FIG. 3) can be located in enclosure 102. Battery core 130 can employ various chemistries. Battery core 130 can include electrolytes (not shown) that are placed in enclosure 102 through fill hole 119. Fill hole 119 can be capped or sealed by seal 120. Details of battery core 130 are shown below in FIG. 4.

Tab 134 (shown in FIG. 3) can connect anode current collectors 410 (shown in FIG. 4) of battery core 130 to enclosure 102. Tab 136 (shown in FIG. 3) can connect cathode current collectors 420 to internal tab 166 (shown in FIG. 3.) Rivet 160 can be riveted to internal tab 166 (shown in FIG. 3) to form a positive terminal for battery 108. Rivet 160 can be insulated by external gasket 162 and internal gasket 164 (shown in FIG. 3). Internal gasket 164 can further insulate internal tab 166. Insulator 148 (shown in FIG. 3) can insulate internal tab 166 from cover 150. Negative weld-pad 170 can be soldered, laser welded, or otherwise fixed to a top surface of flange 140 to provide a negative terminal for battery 108.

This arrangement can provide a battery 108 having flange 140 at a first end and fill hole 119 and its seal 120 at a second end. Flange 140 can be formed by flange portion 118 of top can 110 and an adjacent portion of cover 150. Flange 140 can support rivet 160 and negative weld-pad 170 at a first end of the battery. Fill hole 119 can be in a side of top can 110 at the second end of the battery. By putting fill hole 119 and its seal 120 at a second end, more room is available for rivet 160, the positive terminal, and negative weld-pad 170, the negative terminal on flange 140. This can allow reductions in the width in the direction of the minor axis 182.

These battery cases can have different sizes. For example, battery 108 can have a length along major axis 180 of or approximately 10 mm, 20 mm, 30 mm, 40 mm, 50 mm, or more than 50 mm. Battery 108 can have a length along minor axis 182 of or approximately 4 mm, 5 mm, 7 mm, 9 mm, 11 mm, or more than 11 mm. Battery 108 can have a height of 0.5 mm, 1.0 mm, 1.5 mm, 2.5 mm, 3.0 mm, 4.0 mm, 5.0 mm, or more than 5.0 mm. Enclosure 102 can have a thickness of 50 microns, 75 microns, 100 microns, 150 microns, or more than 150 microns.

In this example, battery 108 can have parallel sides 112 and 114. For example, width 184 can be at least approximately equal to width 186. That is, side 112 can be parallel or nonintersecting with side 114. In these and other embodiments of the present invention, side 112 and side 114 can have other relationships. An example is shown in the following figure.

FIG. 1E and FIG. 1F illustrate a battery having a freeform shape according to an embodiment of the present invention. Battery 109 can be curved or twisted along major axis 180 and can be curved or twisted along minor axis 182. Battery 100 can be flat or substantially flat along major axis 180 and can be flat or substantially flat along minor axis 182. In this example, battery 109 can include straight line for curve 190 for side 112, as well as curved portion 195, curved portion 197, and notch 196 as side 114 in the X direction along major axis 180. Curved portions 195 and 197 can be freeform, that is, the curved portions 195 and 197 might not have a consistent radius of curvature along its length, though in these and other embodiments of the present invention the radius of curvature can be constant. Battery 109 can further include curve 194 in the Z direction along major axis 180. Curve 194 can also be freeform, that is, curve 194 might not have a consistent radius of curvature along its length, though in these and other embodiments of the present invention the radius of curvature could be constant. Battery 109 can further include twist 192 in the minor axis 182 around major axis 180. Twist 192 can also be freeform, that is, twist 192 might not have the same degree of rotation along major axis 180, though in these and other embodiments of the present invention the degree of rotation of twist 192 could be constant.

Battery 109 can be enclosed in a metal can or enclosure 102 that includes top can 110 and cover 150. Top can 110 and cover 150 can be sealed together along or near edge 152 (shown further in FIG. 8) to form enclosure 102. Top can 110 can include flange portion 118. Top can 110 and cover 150 can be formed of metal, they can be metallic, or they can be formed of other materials. Top can 110 and cover 150 can be formed of aluminum, stainless steel, recycled stainless steel or other materials. Top can 110 and cover 150 can be formed by deep drawing, metal injection molding, 3D printing, stamping, extrusion, or other process.

Battery core 130 (shown in FIG. 3) can be located in enclosure 102. Battery core 130 can employ various chemistries. Battery core 130 can include electrolytes (not shown) that are placed in enclosure 102 through fill hole 119. Fill hole 119 can be capped or sealed by seal 120. Details of battery core 130 are shown below in FIG. 4.

Tab 134 (shown in FIG. 3) can connect anode current collectors 410 (shown in FIG. 4) of battery core 130 to enclosure 102. Tab 136 (shown in FIG. 3) can connect cathode current collectors 420 to internal tab 166 (shown in FIG. 3.) Rivet 160 can be riveted to internal tab 166 (shown in FIG. 3) to form a positive terminal for battery 109. Rivet 160 can be insulated by external gasket 162 and internal gasket 164 (shown in FIG. 3). Internal gasket 164 can further insulate internal tab 166. Insulator 148 (shown in FIG. 3) can insulate internal tab 166 from cover 150. Negative weld-pad 170 can be soldered, laser welded, or otherwise fixed to a top surface of flange 140 to provide a negative terminal for battery 109.

This arrangement can provide a battery 109 having flange 140 at a first end and fill hole 119 and its seal 120 at a second end. Flange 140 can be formed by flange portion 118 of top can 110 and an adjacent portion of cover 150. Flange 140 can support rivet 160 and negative weld-pad 170 at a first end of the battery. Fill hole 119 can be in a side of top can 110 at the second end of the battery. By putting fill hole 119 and its seal 120 at a second end, more room is available for rivet 160, the positive terminal, and negative weld-pad 170, the negative terminal on flange 140. This can allow reductions in the width in the direction of the minor axis 182.

These battery cases can have different sizes. For example, battery 109 can have a length along major axis 180 of or approximately 10 mm, 20 mm, 30 mm, 40 mm, 50 mm, or more than 50 mm. Battery 109 can have a length along minor axis 182 of or approximately 4 mm, 5 mm, 7 mm, 9 mm, 11 mm, or more than 11 mm. Battery 109 can have a height of 0.5 mm, 1.0 mm, 1.5 mm, 2.5 mm, 3.0 mm, 4.0 mm, 5.0 mm, or more than 5.0 mm. Enclosure 102 can have a thickness of 50 microns, 75 microns, 100 microns, 150 microns, or more than 150 microns.

In this example, battery 109 can have nonparallel sides 112 and 114. Notch 196 can result in width 184 being wider than width 186. In these and other embodiments of the present invention, side 112 and side 114 can have other relationships.

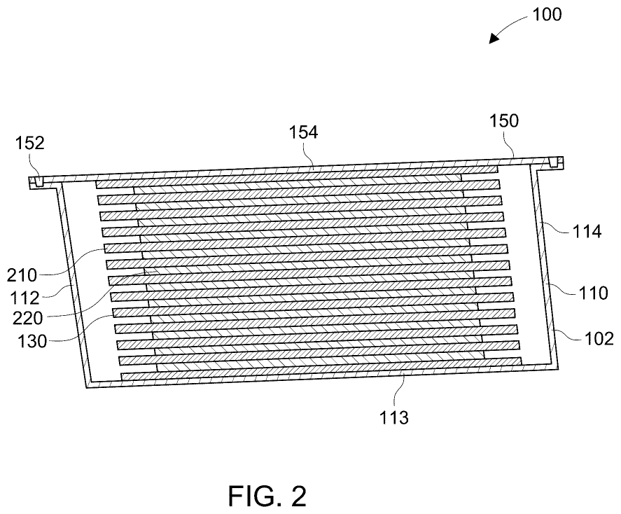

FIG. 2 illustrates a cross-section of the battery of FIG. 1A and FIG. 1B. Battery 100 can include enclosure 102 housing battery core 130. Enclosure 102 can include top can 110 and cover 150. Top can 110 and cover 150 can be sealed along edges 152. Battery core 130 can include anodes 210 and cathodes 220.

Cover 150 can provide top surface 154 for battery 100. Top can 110 can provide bottom surface 113 for battery 100. Top can 110 can further provide side 112 and side 114 for battery 100. In this example, top surface 154 and bottom surface 113 can be parallel in a cross-section. Similarly, side 112 and side 114 can be parallel in a cross-section.

In these and other embodiments of the present invention, enclosure 102 and battery core 130 can have the same or similar curves and contours. This can maximize the volume of battery core 130 in enclosure 102. This can allow battery core to be efficiently placed in enclosure 102.

FIG. 3 is an exploded view of the battery of FIG. 1A and FIG. 1B. Battery 100 can be enclosed in a metal can or enclosure 102 (shown in FIG. 1) that includes top can 110 and cover 150. Top can 110 and cover 150 can be sealed together along or near edge 152 (shown further in FIG. 8) to form enclosure 102. Top can 110 can include overhang 116. This overhang 116 can align with an outer periphery of cover 150. Once top can 110 and cover 150 are sealed together, much of overhang 116 and the outer periphery of cover 150 can be trimmed and recycled.

Top can 110 and cover 150 can be formed of metal, they can be metallic, or they can be formed of other materials. Top can 110 and cover 150 can be formed of aluminum, stainless steel, recycled steel, or other materials. Top can 110 and cover 150 can be formed by deep drawing, metal injection molding, 3D printing, stamping, extruding, or other process.

Battery core 130 can be located in enclosure 102. Battery core 130 can employ various chemistries. Battery core 130 can include electrolytes (not shown) that are placed in enclosure 102 through fill hole 119. Fill hole 119 can be capped or sealed by seal 120. Details of battery core 130 are shown below in FIG. 4.

Tab 134 can connect anode current collectors 410 (shown in FIG. 4) of battery core 130 to enclosure 102. Tab 136 can connect cathode current collectors 420 to internal tab 166. Top can 110 can include flange portion 118. Flange portion 118 can support terminals for battery 100. Specifically, rivet 160 can be riveted to internal tab 166 through opening 111 to form a positive terminal for battery 100. Rivet 160 can be insulated from top can 110 by external gasket 162 and internal gasket 164. Internal gasket 164 can further insulate internal tab 166. Insulator 148 can insulate internal tab 166 from cover 150. Negative weld-pad 170 can be soldered, laser welded, or otherwise fixed to a top surface of flange 140 to provide a negative terminal for battery 100.

FIG. 4 illustrates a cross-section of the battery core used in battery 100 of FIG. 1A and FIG. 1B. Battery core 130 can include anodes 210 and cathodes 220. Anodes 210 can include anode electrodes 212 and anode current collectors 410. Cathodes 220 can include cathode electrodes 222 and cathode current collectors 420. Anodes 210 can be separated from cathodes 220 by separators 430.

Battery core 130 can be molded and trimmed into desired shapes in various ways in these and other embodiments of the present invention. For example, some curves and twists can be imparted to battery core 130 using either a one or two step heat-press method outlined below. However, some curves might be too severe to accomplish with a heat press. In such an example, trimming can be used to provide battery core 130 with such a curve.

For example, battery 100 can include curve 190 (shown in FIG. 1A.) Curve 190 might be too severe to be imposed on battery core 130 using heat press. Accordingly, curve 190 (and the parallel outside curve of battery 100) of battery core 130 can be formed by trimming the layers of battery core 130. This trimming can be done in various ways in various embodiments of the present invention. For example, the trimming can be done one layer at a time, the trimming can be done several layers at a time, or the trimming can be done for all the layers in battery core 130 at the same time. Some of the layers can be trimmed at different times. For example, anodes 210 and cathodes 220 can be trimmed and stacked with one or more untrimmed separators 430. The stack can be heat-pressed one or more times and then the separators 430 can be trimmed.

Battery 100 can further include curve 194 and twist 192. Curve 194 and twist 192 might be imparted to battery core 130 using either a one or two-step heat-press method. While one or two-step heat press methods are shown here, three or more than three heat-press steps can be included. Examples of these methods are shown in the following figures.

In one example, battery core 130 can be heat-pressed between two nonplanar surfaces in order to give curves and twists needed for placement in enclosure 102. But this heat-press step can cause delamination of the various layers of battery core 130. Accordingly, embodiments of the present invention can include an optional step where portions of the various layers of battery core 130 are fixed together in an initial heat-press step. An example of this optional first heat-press step is shown in the following figure.

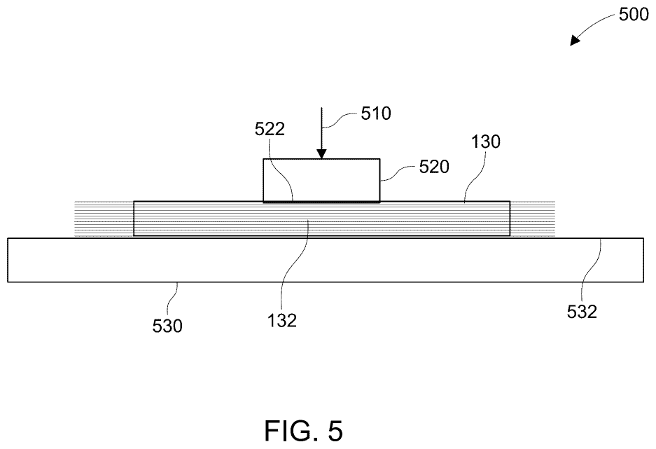

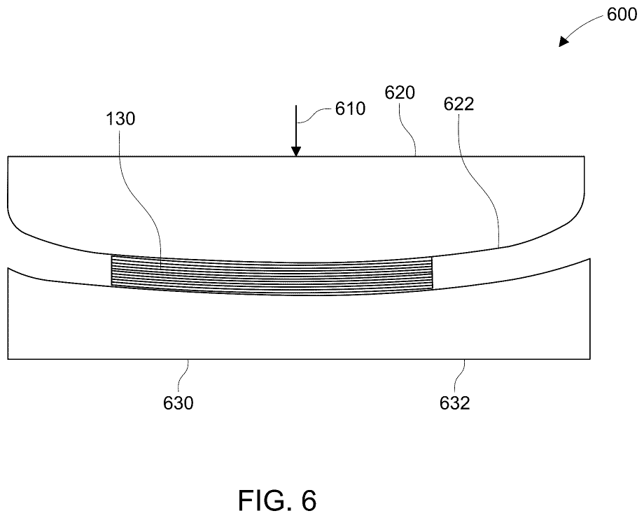

FIG. 5 illustrates an optional first heat-press step used in the formation of a battery core having a freeform shape according to an embodiment of the present invention. In system 500, the layers for region 132 of battery core 130 can be heat-pressed together. Region 132 can be selected as being a region of low stress and shear. These low stress and low shear attributes can help prevent delamination in region 132. Selecting a low shear area can help to avoid a situation where portions of battery core 130 layers are laminated, only to then be separated and relaminated during the following heat-press steps shown in FIG. 6, an event which could be destructive.

Region 132 can be heat pressed between surface 522 of block 520 and surface 532 of block 530. Surface 522 and surface 532 can be planar or nonplanar. Surface 522 and surface 532 can be parallel surfaces. Force 510 can be applied to block 520. Surface 522 of block 520 can be heated and pushed into region 132 of battery core 130 by force 510. Battery core 130 can be supported by surface 532 of block 530. Surface 532 of block 530 can be heated as well.

In this example, block 520 is shown as applying force 510 at region 132 of battery core 130. In these and other embodiments of the present invention, block 520 can apply force 510 across all of battery core 130. In these and other embodiments of the present invention, more than one block 520 can apply forces 510, which can have the same or different magnitudes, to various portions of battery core 130.

The pressure applied by force 510 and the heating provided by either or both block 520 at surface 522 and block 530 at surface 532 can increase an adhesion among layers of battery core 130, thereby preventing delamination in the following heat-press step, as shown in the following figure.

Again, battery core 130 can be heat-pressed between two nonplanar surfaces in order to give curves and twists needed for placement in enclosure 102. This heat-press step can cause delamination and separation of the layers of battery core 130. As shown above, to help prevent or reduce this delamination, a first heat-press step can be utilized as shown in FIG. 5. In these and other embodiments of the present invention, particularly where the curves and twists that are imparted are minimal, this second heat-press step can be utilized on its own without the optional first heat-press step.

FIG. 6 illustrates a second heat-press step used in the formation of a battery core having a freeform shape according to an embodiment of the present invention. In system 600, layers of battery core 130 can be heat pressed together. Battery core 130 can be heat pressed between block 620 and block 630. Force 610 can be applied to block 620. Surface 622 of block 620 can be heated and pushed into battery core 130 by force 610. Battery core 130 can be supported by surface 32 of block 630. Surface 632 of block 630 can be heated as well. The pressure applied by force 610 and the heating provided by either or both block 620 at surface 632 and block 630 at surface 632 can curve and twist battery core 130 into a desired contour for insertion into enclosure 102 (shown in FIG. 1.)

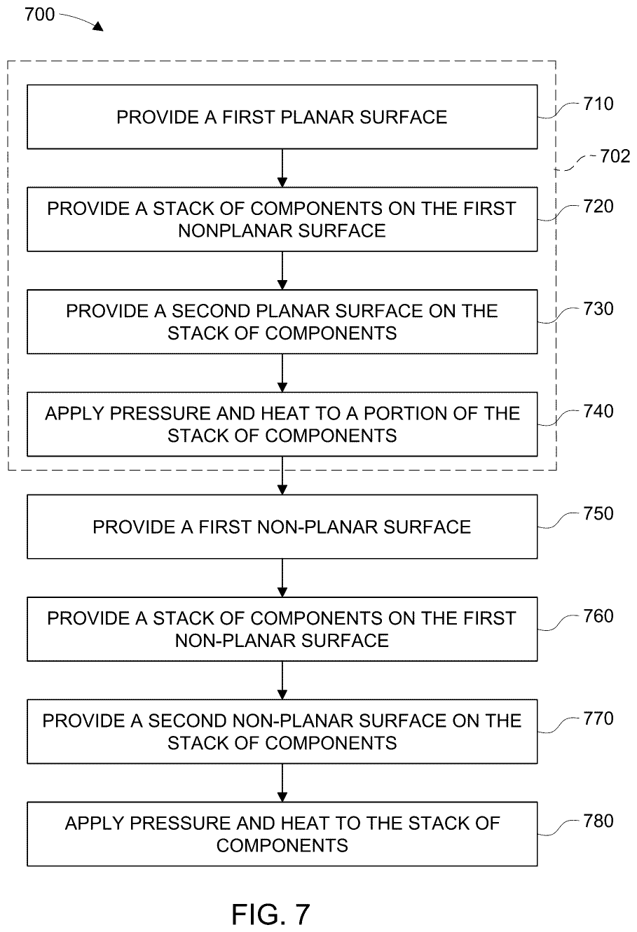

FIG. 7 is a flowchart of a method of manufacturing a battery core having a freeform shape according to an embodiment of the present invention. In method 700, acts 702 can be optional. Acts 702 outline a first optional step in a one or two-step heat press method. In act 710, a first surface can be provided. In act 720, a stack of components, such as those comprising battery core 130 (shown in FIG. 4) can be placed on the first surface. In act 730, a second surface can be provided on the stack of components. The first surface and the second surface can be planar or nonplanar. The first surface and the second surface can be parallel. Pressure and heat can be applied to either a portion, a number of portions, or all of the stack of components in act 740 by the first surface and the second surface. Either or both the first surface and the second surface can be heated. In these and other embodiments of the present invention, the portion of the stack of components can be selected for having a low curvature and twist. This can reduce the stress and shear force on the portion of the stack of components thereby preventing their delamination and separation. Selecting a low shear area can help to avoid a situation where portions of battery core layers are laminated, only to then be separated and relaminated during the following heat-press steps of the subsequent acts, an event which could be destructive.

Once the optional first heat-press step is complete, a second press step can occur. Specifically, a first nonplanar surface can be provided in act 750. A stack of components, for example, components for battery core 130, can be placed on the first nonplanar surface in act 760. This stack of components can be the same stack of components that underwent the optional first heat-press acts 702, or it can be a different stack of components when the optional first heat-press acts 702 were not performed. In act 770, a second nonplanar surface can be provided to the top side of the stack of components. In act 780, pressure and heat can be applied to the stack of components.

In these and other embodiments of the present invention, top can 110 and cover 150 can be sealed along edge 152 (all shown in FIG. 1.) More specifically, overhang 116 of top can 110 can align with an outer edge of cover 150. Overhang 116 and the outer edge of cover 150 can be sealed, and overhang 116 and outer edge of cover 150 can be trimmed. The trimmed portions can then be recycled.

The sealing along edge 152 can be difficult. For example, cover 150 can include curves and twists. When edge 152 is sealed using a laser, the distance from the laser to edge 152 can vary with position across cover 150. An example of this is shown in the following figure.

FIG. 8 illustrates a system for sealing an enclosure for the battery of FIG. 1A and FIG. 1B. Sealing system 800 can include laser 810. Laser 810 can move in the X and Y directions to provide a moving laser. In this example, top can 110 can be sealed to cover 150 along an edge 152.

But a distance from laser 810 to edge 152 can vary with the X and Y position of laser 810. Accordingly, laser 810 can refocus its focal length for different locations along edge 152. In this example, at location 153, a focal length of laser 810 might need to be FL1. At location 155, a focal length of laser 810 might need to be a different focal length FL2. Similarly, at location 157, a focal length of laser 810 might need to be a different focal length FL3. Accordingly, as laser 810 moves among location 153, location 155, and location 157, the focal length of laser 810 can be adjusted accordingly.

In these and other embodiments of the present invention, laser 810 can be fixed in position relative to enclosure 102. As before, laser 810 can refocus its focal length for different locations along edge 152. In this example, at location 153, a focal length of laser 810 might need to be FL4. At location 155, a focal length of laser 810 might need to once again be the focal length FL2. Similarly, at location 157, a focal length of laser 810 might need to be a different focal length FL5. Accordingly, when laser 810 is fixed in position relative to enclosure 102 and lasering location 153, location 155, and location 157, the focal length of laser 810 can be adjusted accordingly.

Once top can 110 is sealed to cover 150, overhang 116 of top can 110 and a corresponding portion of cover 150 can be trimmed or cut away. The trimmed portion can then be recycled.

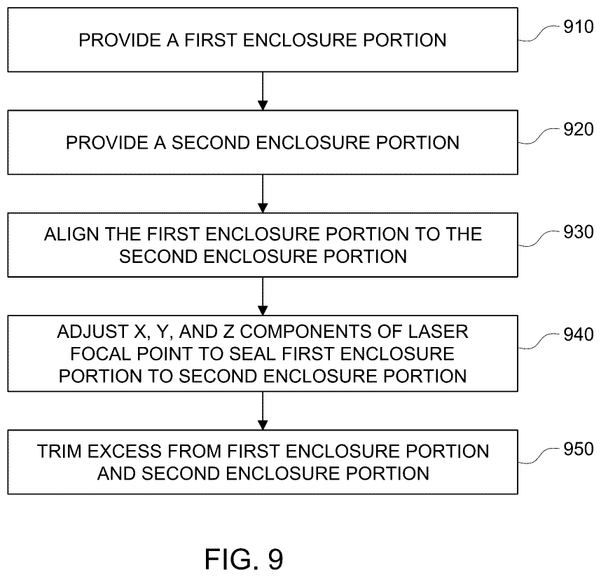

FIG. 9 illustrates a method of sealing an enclosure for a battery having a freeform shape according to an embodiment of the present invention. In act 910, a first enclosure portion can be provided. The first enclosure portion can be a top can or other enclosure portion. In act 920, a second enclosure portion can be provided. The second enclosure portion can be a cover, a bottom can, or other enclosure portion. The first enclosure portion the second enclosure portion can be aligned in act 930.

In act 940, the X, Y, Z components of a laser focal point can be adjusted in order to seal the first enclosure portion the second enclosure portion. Excess portion can be trimmed from the first enclosure portion and the second enclosure portion in act 950.

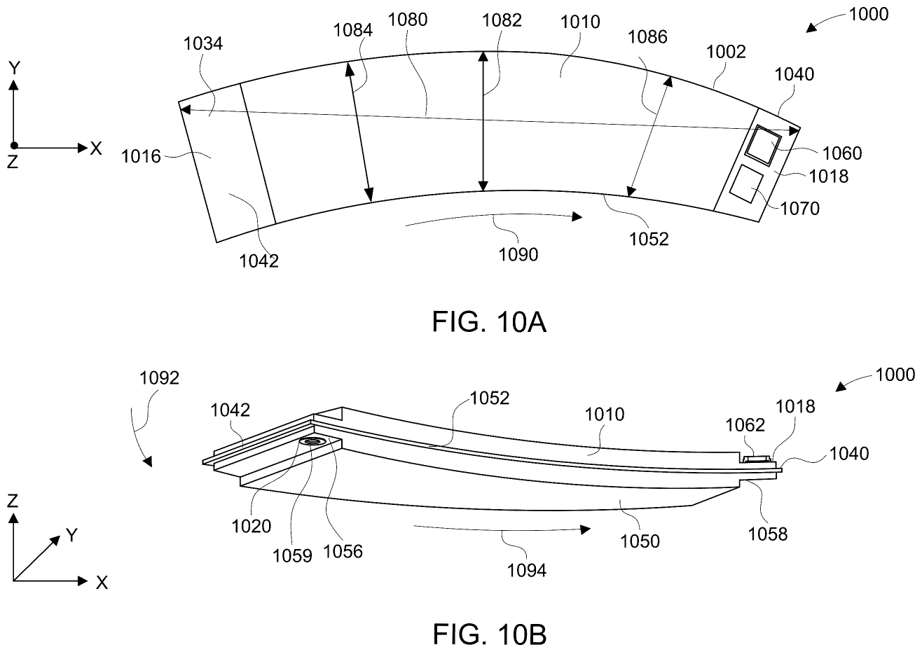

FIG. 10A and FIG. 10B illustrate another battery having a freeform shape according to an embodiment of the present invention. Battery 1000 can be curved or twisted along major axis 1080 and can be curved or twisted along minor axis 1082. In this example, battery 1000 can include curve 1090 in the X direction along major axis 1080. Curve 1090 can be freeform, that is, curve 1090 might not have a consistent radius of curvature along its length, though in these and other embodiments of the present invention the radius of curvature can be constant. Battery 1000 can further include curve 1094 in the Y direction along major axis 1080. Curve 1094 can also be freeform, that is, curve 1094 might not have a consistent radius of curvature along its length, though in these and other embodiments of the present invention the radius of curvature could be constant. Battery 1000 can further include twist 1092 in the minor axis 1082 around major axis 1080. Twist 1092 can also be freeform, that is, twist 1092 might not have the same degree of rotation along major axis 1080, though in these and other embodiments of the present invention the degree of rotation of twist 1092 could be constant.

Battery 1000 can be enclosed in a metal can or enclosure 1002 that includes top can 1010 and bottom can 1050. Top can 1010 and bottom can 1050 can be sealed together along or near edge 1052 (shown further in FIG. 8) to form enclosure 1002. Top can 1010 can include first flange portion 1018 and second flange portion 1016. Bottom can 1050 can include first flange portion 1058 and second flange portion 1056. The first flange portion 1018 of top can 1010 and first flange portion 1058 of bottom can 1050 can form first flange 1040. The second flange portion 1016 of top can 1010 and second flange portion 1056 of bottom can 1050 can form second flange 1042. Top can 1010 and bottom can 1050 can be formed of metal, they can be metallic, or they can be formed of other materials. Top can 1010 and bottom can 1050 can be formed of aluminum, stainless steel, recycled stainless steel, or other materials. Top can 1010 and bottom can 1050 can be formed by deep drawing, metal injection molding, 3D printing, stamping, extrusion, or other process.

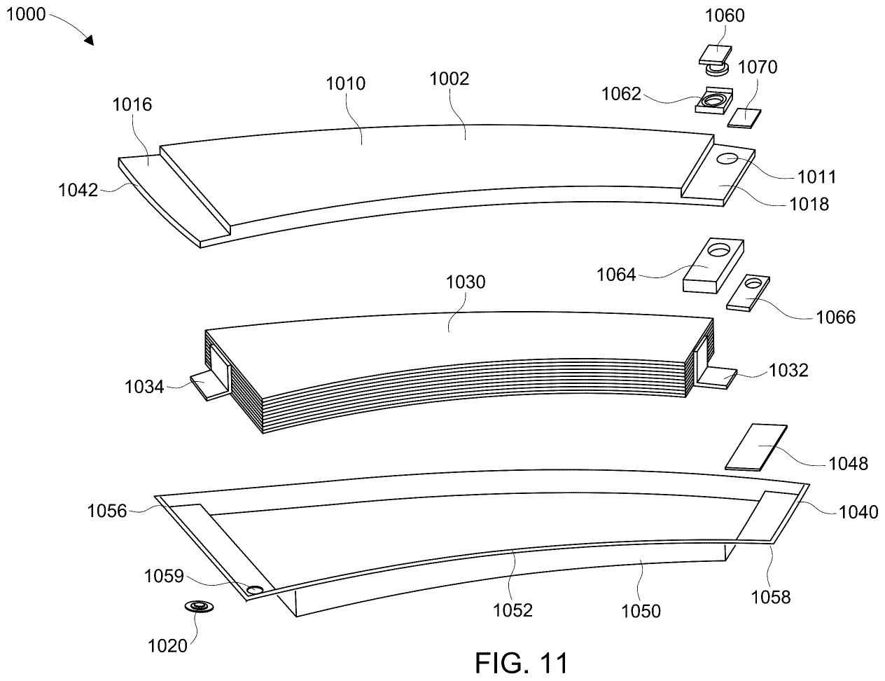

Battery core 1030 (shown in FIG. 11) can be located in enclosure 1002. Battery core 1030 can employ various chemistries. Battery core 1030 can include electrolytes (not shown) that are placed in enclosure 1002 through fill hole 1059. Fill hole 1059 can be capped or sealed by seal 1020. Details of battery core 1030, which can be the same or similar to battery core 130 (shown in FIG. 4), are shown above in FIG. 4.

Tab 1034 (shown in FIG. 11) can connect anode current collectors 410 (shown in FIG. 4) of battery core 1030 (shown in FIG. 11) to enclosure 1002. Tab 1032 can connect cathode current collectors 420 (shown in FIG. 4) to internal tab 1066 (shown in FIG. 11.) Rivet 1060 can be riveted to internal tab 1066 to form a positive terminal for battery 1000. Rivet 1060 can be insulated by external gasket 1062 and internal gasket 1064 (shown in FIG. 11). Internal gasket 1064 can further insulate internal tab 1066. Insulator 1048 (shown in FIG. 11) can insulate internal tab 1066 from bottom can 1050. Negative weld-pad 1070 can be soldered, laser welded, or otherwise attached to a top surface of first flange 1040 to provide a negative terminal for battery 1000.

In this example, a second flange 1042 can be provided by enclosure 102. Second flange 1042 can support fill hole 1059. This arrangement can avoid having to place fill hole 1059 in first flange 1040 with the power terminals and other structures. Also, sides of top can 1010 and bottom can 1050 can have insufficient width to support fill hole 1059 and seal 1020.

This arrangement can provide a battery 1000 having first flange 1040 at a first end and second flange 1042 at a second end. First flange 1040 can be formed by first flange portion 1018 of top can 1010 and first flange portion 1058 of bottom can 1050. First flange 1040 can support rivet 1060 and negative weld-pad 1070 at a first end of the battery. Fill hole 1059 and its seal can be positioned on second flange 1042. By putting fill hole 1059 and its seal 1020 on second flange 1042, more room is available for rivet 1060, the positive terminal, and negative weld-pad 1070, the negative terminal on first flange 1040. This can allow reductions in the width in the direction of the minor axis 1082.

These battery cases can have different sizes. For example, battery 1000 can have a length along major axis 1080 of or approximately 10 mm, 20 mm, 30 mm, 40 mm, 50 mm, or more than 50 mm. Battery 1000 can have a length along minor axis 1082 of or approximately 4 mm, 5 mm, 7 mm, 9 mm, 11 mm, or more than 11 mm. Battery 1000 can have a height of 0.5 mm, 1.0 mm, 1.5 mm, 2.5 mm, 3.0 mm, 4.0 mm, 5.0 mm, or more than 5.0 mm. Enclosure 1002 can have a thickness of 50 microns, 75 microns, 100 microns, 150 microns, or more than 150 microns.

In this example, battery 1000 can taper towards flange 1040. For example, width 1084 can be greater than width 1086. That is, side 112 can be nonparallel or oblique to side 114 (both shown in FIG. 2.) In these and other embodiments of the present invention, side 112 can be parallel to side 114. In these and other embodiments of the present invention, side 112 can have other relationships to side 114, such as that shown in FIG. 1E and FIG. 1F.

FIG. 11 is an exploded view of the battery of FIG. 10A and FIG. 10B. Battery 1000 can be enclosed in a metal can or enclosure 1002 (shown in FIG. 10) that includes top can 1010 and bottom can 1050. Top can 1010 and bottom can 1050 can be sealed together along or near edge 1052 (similar to edge 152 shown in FIG. 8) to form enclosure 1002. Top can 1010 and bottom can 1050 can each include an overhang portion (not shown.) These overhang portions can align. Once top can 1010 and bottom can 1050 are sealed together, much of overhang portions can be trimmed and recycled.

Top can 1010 and bottom can 1050 can be formed of metal, they can be metallic, or they can be formed of other materials. Top can 1010 and bottom can 1050 can be formed of aluminum, stainless steel, recycled stainless steel, or other materials. Top can 1010 and bottom can 1050 can be formed by deep drawing, metal injection molding, 3D printing, stamping, extrusion, or other process.

Battery core 1030 can be located in enclosure 1002. Battery core 1030 can employ various chemistries. Battery core 1030 can include electrolytes (not shown) that are placed in enclosure 1002 through fill hole 1059. Fill hole 1059 can be capped or sealed by seal 1020. Details of battery core 1030 are shown above in FIG. 4. Top can 1010 can include second flange portion 1016, while bottom can 1050 can include second flange portion 1056. Second flange portion 1016 of top can 1010 and second flange portion 1056 of bottom can 1050 can form second flange 1042. Second flange 1042 can support fill hole 1059.

Tab 1034 can connect anode current collectors 410 (shown in FIG. 4) of battery core 1030 to enclosure 1002. Tab 1032 can connect cathode current collectors 420 to internal tab 1066. Top can 1010 can include first flange portion 1018, while bottom can 1050 can include first flange portion 1058. First flange portion 1018 of top can 1010 and first flange portion 1058 of bottom can 1050 can form first flange 1040. First flange 1040 can support terminals for battery 1000. Specifically, rivet 1060 can be riveted through hole 1011 to internal tab 1066 to form a positive terminal for battery 1000. Rivet 1060 can be insulated by external gasket 1062 and internal gasket 1064. Internal gasket 1064 can further insulate internal tab 1066. Insulator 1048 can insulate internal tab 1066 from bottom can 1050. Negative weld-pad 1070 can be soldered, laser welded, or otherwise fixed to a top surface of first flange 1040 to provide a negative terminal for battery 1000.

These and other embodiments of the present invention can provide batteries having various shapes. For example, a battery can be curved or flat in one or more dimensions. An example is shown in the following figures.

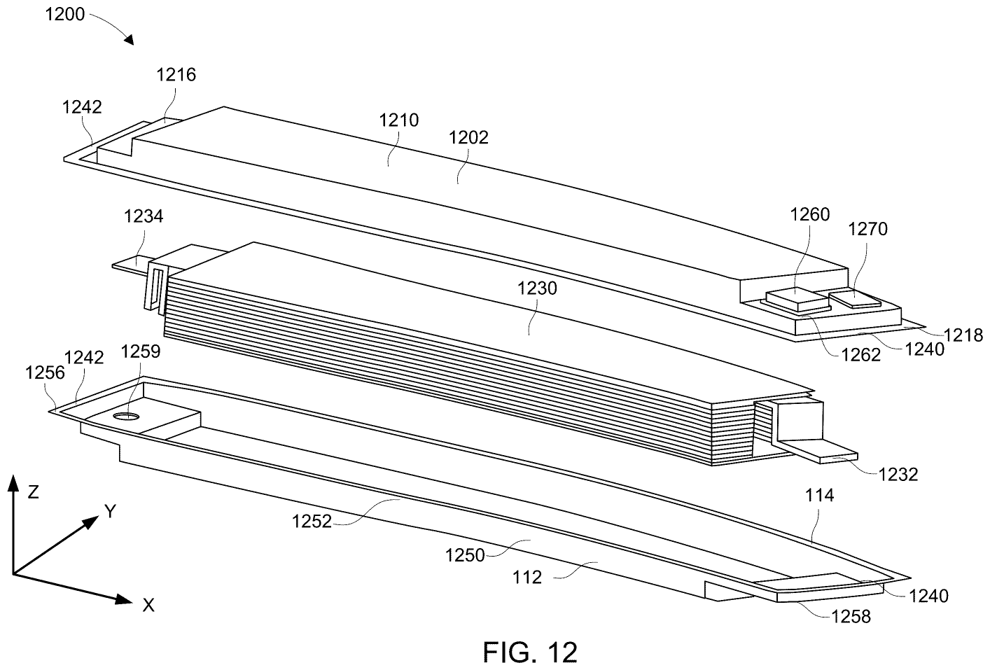

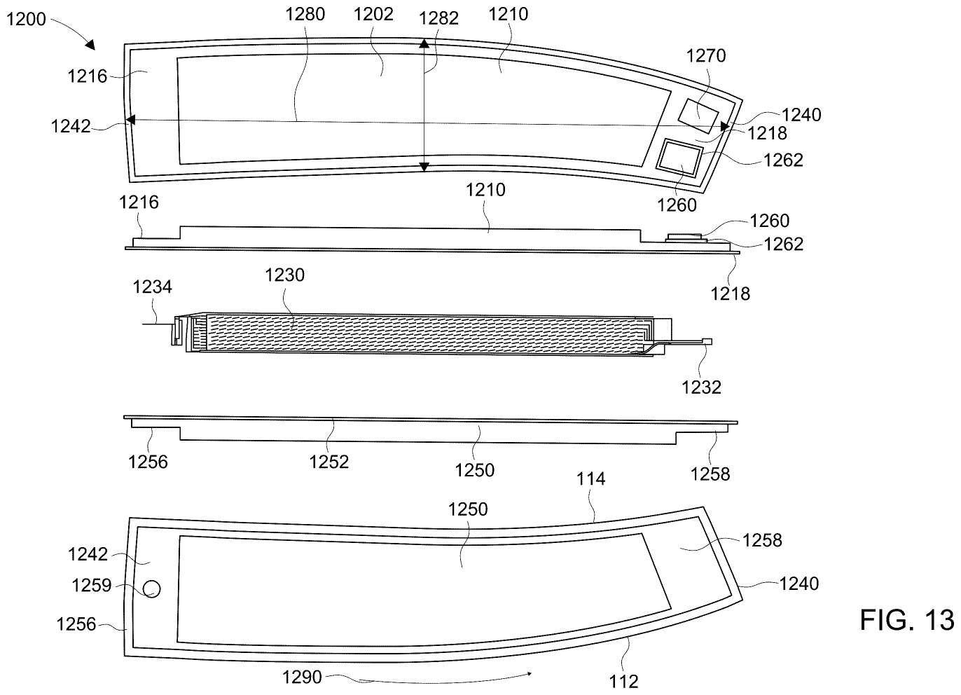

FIG. 12 is an exploded view of another battery according to an embodiment of the present invention. Battery 1200 can be curved or twisted along major axis 1280 and can be curved or twisted along minor axis 1282 (both shown in FIG. 13.) In this example, battery 1200 can be flat or substantially flat along major axis 1280 and can be flat or substantially flat along minor axis 1282. Battery 1200 can include curve 1290 (shown in FIG. 13) in the X direction along major axis 1280. Curve 1290 can be freeform, that is, curve 1290 might not have a consistent radius of curvature along its length, though in these and other embodiments of the present invention the radius of curvature can be constant.

Battery 1200 can be enclosed in a metal can or enclosure 1202 that includes top can 1210 and bottom can 1250. Top can 1210 and bottom can 1250 can be sealed together along or near edge 1252 (shown further in FIG. 8) to form enclosure 1202. Top can 1210 can include first flange portion 1218 and second flange portion 1216. Bottom can 1250 can include first flange portion 1258 and second flange portion 1256. The first flange portion 1218 of top can 1210 and first flange portion 1258 of bottom can 1250 can form first flange 1240. The second flange portion 1216 of top can 1210 and second flange portion 1256 of bottom can 1250 can form second flange 1242. Top can 1210 and bottom can 1250 can be formed of metal, they can be metallic, or they can be formed of other materials. Top can 1210 and bottom can 1250 can be formed of aluminum, stainless steel, recycled stainless steel, or other materials. Top can 1210 and bottom can 1250 can be formed by deep drawing, metal injection molding, 3D printing, stamping, extrusion, or other process.

Battery core 1230 can be located in enclosure 1202. Battery core 1230 can employ various chemistries. Battery core 1230 can include electrolytes (not shown) that are placed in enclosure 1202 through fill hole 1259. Fill hole 1259 can be capped or sealed by seal 1220. Details of battery core 1230, which can be the same or similar to battery core 130 (shown in FIG. 4), are shown above in FIG. 4.

Tab 1234 can connect anode current collectors 410 (shown in FIG. 4) of battery core 1230 to enclosure 1202. Tab 1232 can connect cathode current collectors 420 (shown in FIG. 4) to internal tab 1066 (shown in FIG. 11.) Rivet 1260 can be riveted to internal tab 1066 to form a positive terminal for battery 1200. Rivet 1260 can be insulated by external gasket 1262 and internal gasket 1064 (shown in FIG. 11). Internal gasket 1064 can further insulate internal tab 1066. Insulator 1048 (shown in FIG. 11) can insulate internal tab 1066 from bottom can 1250. Negative weld-pad 1270 can be soldered, laser welded, or otherwise attached to a top surface of first flange 1240 to provide a negative terminal for battery 1200.

In this example, a second flange 1242 can be provided by enclosure 122. Second flange 1242 can support fill hole 1259. This arrangement can avoid having to place fill hole 1259 in first flange 1240 with the power terminals and other structures. Also, sides of top can 1210 and bottom can 1250 can have insufficient width to support fill hole 1259 and seal 1220.

This arrangement can provide a battery 1200 having first flange 1240 at a first end and second flange 1242 at a second end. First flange 1240 can be formed by first flange portion 1218 of top can 1210 and first flange portion 1258 of bottom can 1250. First flange 1240 can support rivet 1260 and negative weld-pad 1270 at a first end of the battery. Fill hole 1259 and a seal (not shown) can be positioned on second flange 1242. By putting fill hole 1259 and its seal 1220 on second flange 1242, more room is available for rivet 1260, the positive terminal, and negative weld-pad 1270, the negative terminal on first flange 1240. This can allow reductions in the width in the direction of the minor axis 1282.

These battery cases can have different sizes. For example, battery 1200 can have a length along major axis 1280 of or approximately 10 mm, 20 mm, 30 mm, 40 mm, 50 mm, or more than 50 mm. Battery 1200 can have a width along minor axis 1282 of or approximately 4 mm, 5 mm, 7 mm, 9 mm, 11 mm, or more than 11 mm. Battery 1200 can have a height of 0.5 mm, 1.0 mm, 1.5 mm, 2.5 mm, 3.0 mm, 4.0 mm, 5.0 mm, or more than 5.0 mm. Enclosure 1202 can have a thickness of 50 microns, 75 microns, 100 microns, 150 microns, or more than 150 microns.

In this example, battery 1200 can taper towards flange 1240. That is, side 112 can be nonparallel or oblique to side 114 (both also shown in FIG. 2.) In these and other embodiments of the present invention, side 112 can be parallel to side 114. In these and other embodiments of the present invention, side 112 can have other relationships to side 114, such as that shown in FIG. 1E and FIG. 1F. Top can 1210 can provide a top surface for enclosure 1202. Bottom can 1250 can provide a bottom surface for enclosure 1202. The top surface of top can 1210 and the bottom surface of bottom can 1250 can be parallel. The top surface of top can 1210 and the bottom surface of bottom can 1250 can be nonparallel.

FIG. 13 is another exploded view the battery of FIG. 12. Battery 1200 can be enclosed in a metal can or enclosure 1202 (shown in FIG. 12) that includes top can 1210 and bottom can 1250. Enclosure 1202 of battery 1200 can have a major or longitudinal axis 1280 and a minor or latitudinal axis 1282. Side 112 and side 114 can include curves 1290. Side 112 and side 114 can be nonparallel. Side 112 and side 114 can be parallel.

Top can 1210 and bottom can 1250 can be sealed together along or near edge 1252 (similar to edge 152 shown in FIG. 8) to form enclosure 1202. Top can 1210 and bottom can 1250 can each include an overhang portion along an outer edge. These overhang portions can align. Once top can 1210 and bottom can 1250 are sealed together, much of overhang portions can be trimmed and recycled.

Top can 1210 and bottom can 1250 can be formed of metal, they can be metallic, or they can be formed of other materials. Top can 1210 and bottom can 1250 can be formed of aluminum, stainless steel, recycled stainless steel, or other materials. Top can 1210 and bottom can 1250 can be formed by deep drawing, metal injection molding, 3D printing, stamping, extrusion, or other process.

Battery core 1230 can be located in enclosure 1202. Battery core 1230 can employ various chemistries. Battery core 1230 can include electrolytes (not shown) that are placed in enclosure 1202 through fill hole 1259. Fill hole 1259 can be capped or sealed by seal 1220. Details of battery core 1230 are shown above in FIG. 4. Top can 1210 can include second flange portion 1216, while bottom can 1250 can include second flange portion 1256. Second flange portion 1216 of top can 1210 and second flange portion 1256 of bottom can 1250 can form second flange 1242. Second flange 1242 can support fill hole 1259.

Tab 1234 can connect anode current collectors 410 (shown in FIG. 4) of battery core 1230 to enclosure 1202. Tab 1232 can connect cathode current collectors 420 (shown in FIG. 4) to internal tab 1066 (shown in FIG. 11.) Top can 1210 can include first flange portion 1218, while bottom can 1250 can include first flange portion 1258. First flange portion 1218 of top can 1210 and first flange portion 1258 of bottom can 1250 can form first flange 1240. First flange 1240 can support terminals for battery 1200. Specifically, rivet 1260 can be riveted through hole 1011 (shown in FIG. 11) to internal tab 1066 to form a positive terminal for battery 1200. Rivet 1260 can be insulated by external gasket 1262 and internal gasket 1064 (shown in FIG. 11.) Internal gasket 1064 can further insulate internal tab 1066. Insulator 1048 (shown in FIG. 11) can insulate internal tab 1066 from bottom can 1250. Negative weld-pad 1270 can be soldered, laser welded, or otherwise fixed to a top surface of first flange 1240 to provide a negative terminal for battery 1200.

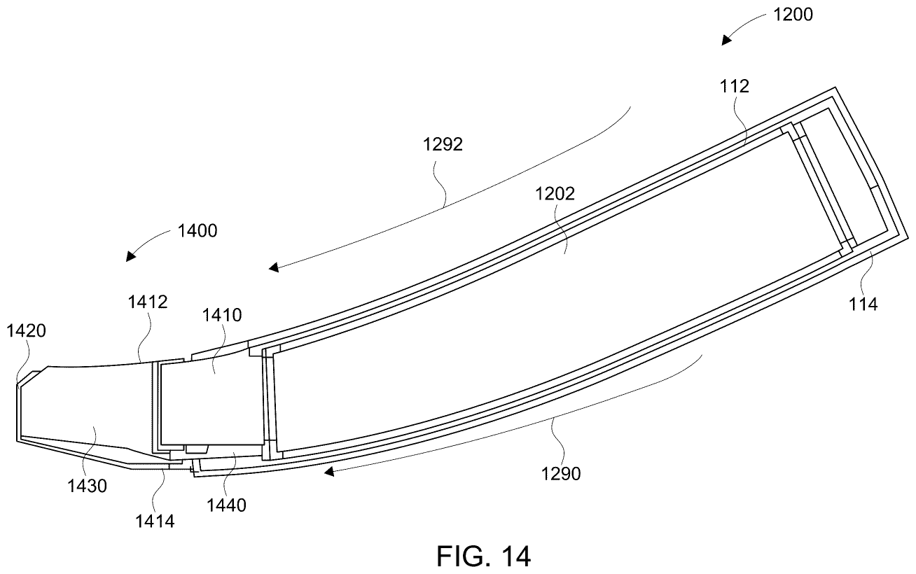

FIG. 14 illustrates the battery of FIG. 12 with battery pack components according to an embodiment of the present invention. In this example, battery 1200 can be attached to battery pack components 1400 that include insulator 1410 and tape 1440 over rivet 1260 and negative weld-pad 1270 (shown in FIG. 13), as well as bottom cap 1430 over board 1420. A top cap (not shown) can be positioned under board 1420. Board 1420 can connect to rivet 1260 and negative weld-pad 1270. Board 1420 can support one or more of a connector, a protection circuit module, a battery management unit, or other components (not shown.)

In these and other embodiments of the present invention, the battery pack components can be the same or different components. For example, they can include a board (not shown) connected to rivet 1260 and negative weld-pad 1270. This board can support one or more of a connector, a protection circuit module, a battery management unit, or other components (not shown.) Tape and an insulator (not shown) can be used to protect battery connections to rivet 1260 and negative weld-pad 1270. A bottom cap (not shown) can support the board.

The battery pack components 1400 can be arranged to have a first side 1412 and a second side 1414. The first side 1412 of battery pack components 1400 can follow a similar or same curve 1292 as first side 112 of battery 1200 enclosure 1202. The second side 1414 of battery pack components 1400 can follow a similar or same curve 1290 as second side 114 of battery 1200 enclosure 1202. Curve 1290 can be different than curve 1292. First side 1412 of battery pack components 1400 can be at least approximately contiguous with first side 112 of battery 1200 enclosure 1202. Second side 1414 of battery pack components 1400 can be at least approximately contiguous with second side 114 of battery 1200 enclosure 1202. First side 1412 and second side 1414 of battery pack components 1400 can be nonparallel.

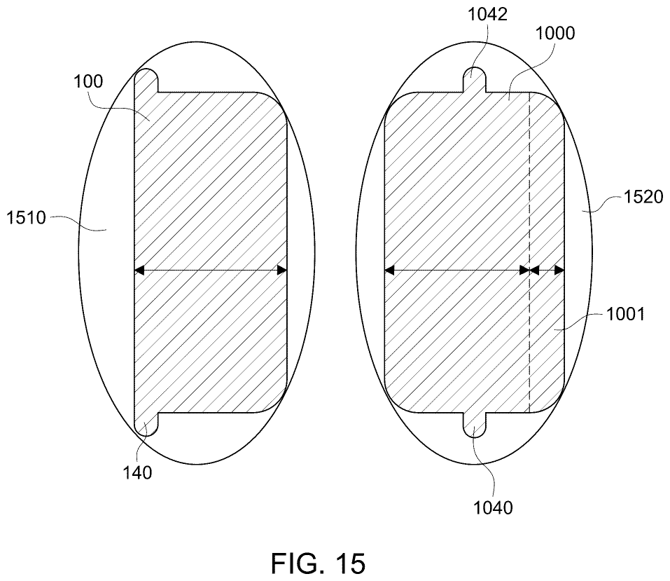

FIG. 15 illustrates cross-section views of the battery of FIG. 1A and FIG. 1B and the battery of FIG. 10A and FIG. 10B positioned in corresponding electronic devices according to an embodiment of the present invention. Battery 100 can be positioned in electronic device 1510. Battery 100 can include flange 140. Battery 1000 can be positioned in electronic device 1520. Battery 1000 can include first flange 1040 and second flange 1042. Having first flange 1040 and second flange 1042 close to a middle of sides of battery 1000 can allow battery 1000 to be positioned more centrally in electronic device 1520 as compared to battery 100 in electronic device 1510. Again, first flange 1040 and second flange 1042 can be referred to as mid-plane flanges. This positioning of the flanges can allow battery 1000 to have the additional capacity 1001 as compared to battery 100.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

1. A battery comprising:
an enclosure housing the battery, the enclosure having a minor axis and a major axis and comprising a top can and a bottom can, the top can and bottom can forming a first side and a second side along the major axis, wherein the first side and the second side are nonparallel;
a plurality of anodes coupled to a first terminal of the battery;
a plurality of cathodes, each cathode between two of the plurality of anodes and coupled to a second terminal of the battery; and
a plurality of separators, each around a corresponding cathode.

2. The battery of claim 1 wherein a top surface of the top can and a bottom surface of the bottom can are parallel.

3. The battery of claim 1 wherein a top surface of the top can and a bottom surface of the bottom can are nonparallel.

4. The battery of claim 3 wherein the first side and the second side along the major axis are curved.

5. (canceled)

6. The battery of claim 1 wherein a top surface of the top can is curved along one or both of the major axis and the minor axis.

7. The battery of claim 6 wherein the top surface is twisted along one or both of the major axis and the minor axis.

8. (canceled)

9. The battery of claim 1 further comprising:
battery pack components coupled to the first terminal of the battery and the second terminal of the battery, the battery pack components having a first side and a second side, wherein the first side of the battery and the first side of the battery pack components follow a first curve and the second side of the battery and the second side of the battery pack components follow a second curve, the first curve different than the second curve.

10. The battery of claim 9 wherein the first side of the battery and the first side of the battery pack components are approximately contiguous and the second side of the battery and the second side of the battery pack components are approximately contiguous, wherein the first side of the battery pack components and the second side of the battery pack components are nonparallel.

11. The battery of claim 10 wherein the battery pack components comprise:
a first terminal to connect to the first terminal of the battery;
a second terminal to connect to the second terminal of the battery; and
at least one of a protection circuit or a battery management unit.

12. A battery comprising:
a metal can housing the battery, the metal can comprising a top can having a top surface and a bottom can having a bottom surface, the metal can further comprising a first flange extending from a first end and a second flange extending from a second end;
a plurality of anodes;
a plurality of cathodes, each cathode between two of the plurality of anodes;
a plurality of separators, each around a corresponding cathode;
an electrical terminal on the first flange; and
a fill hole to provide access to an interior of the metal can on the second flange.

13. The battery of claim 12 further comprising a fill plug to seal the fill hole.

14. The battery of claim 13 wherein the top surface is non-planar and the bottom surface is non-planer, and wherein the top surface and the bottom surface are parallel.

15. The battery of claim 14 wherein the battery has a minor axis and a major axis, and the metal can has a first side and a second side along the major axis, wherein the first side and the second side are curved and wherein the first side and the second side are parallel.

16. The battery of claim 15 wherein the top surface is curved along one or both of the major axis and the minor axis.

17. The battery of claim 16 wherein the top surface is twisted along one or both of the major axis and the minor axis.

18. The battery of claim 12 wherein the metal can comprises:
a top portion having a recess and a first overhanging edge; and
a bottom portion having a recess and a second overhanging edge,
wherein the first overhanging edge and the second overhanging edge align to form the first flange and the second flange.

19. A method of forming a battery, the method comprising:
providing a first non-planar surface;
providing a stack of components on the first non-planar surface;
providing a second non-planar surface to the stack of components such that the stack of components is between the first non-planar surface and the second non-planar surface;
applying heat to the stack of components; and
applying pressure to the stack of components,
wherein the stack of components comprises a plurality of anodes separated from each other by cathodes in a plurality of cathodes.

20. The method of claim 19 further comprising:
placing the stack of components in a metal can, wherein the metal can is arranged to be sealed along a non-planar edge; and
sealing the metal can along the non-planar edge with a laser, wherein the focal length of the laser is varied as the metal can is sealed.

21. The method of claim 20 further comprising, before providing the stack of components on the first non-planar surface:
providing the stack of components on a first planar surface:
applying a second planar surface to a portion of the stack of components;
applying heat to the portion of the stack of components; and
applying pressure to the portion of the stack of components.

22. The method of claim 19 wherein the first non-planar surface and the second non-planar surface are parallel when applying the heat and the pressure to the stack of components.
